(19) United States
(12) Patent Application Publication
(10) Pub. No.: US 2004/0253084 A1
(43) Pub. Date: Dec. 16, 2004

(54) Tire carrier

(75) Inventors: Madhu Posani, Bloomfield Hills, MI (US); Casimir R. Kiczek, Livonia, MI (US); Jason Hana, Madison Heights, MI (US)

Correspondence Address: Dura Automotive, 2791 Research Drive, Rochester Hills, MI, 48309-3575, US

(73) Assignee: Dura Global Technologies, Inc.

(21) Appl. No.: 10/839,417

(22) Filed: May 4, 2004

Related U.S. Application Data
(60) Provisional application No. 60/471,613, filed on May 16, 2003.

(51) Int. Cl. B62D 43/00

(52) U.S. Cl. 414/463

(57) ABSTRACT

A spare tire carrier with an annular sleeve member is disposed about a flexible member. A stop is attached to the sleeve. The sleeve has one end, an opposite end, an inner surface and one of a polymeric layer, a contoured interior surface and a polymeric insert to prevent wear and failure of the flexible member. The interior surface forms a flared inside surface that extends from the one end toward the opposite end. The inside surface defines a first diameter D1 near the one end, a second diameter D2 extending away from the one end and a length L that extends between D1 and D2. The difference between D1 and D2 divided by L is in a predetermined range. A method of preventing failure to the flexible member with a contoured surface, a polymeric insert or a polymeric layer is also disclosed.

### CROSS-REFERENCE TO RELATED APPLICATIONS

This application claims the benefit of corresponding U.S. Provisional Application 60/471,613 filed on May 16, 2003.

### STATEMENT REGARDING FEDERALLY SPONSORED RESEARCH

Not Applicable

### REFERENCE TO MICROFICHE APPENDIX

Not Applicable

### FIELD OF INVENTION

The present invention relates to tire carriers and specifically to a tire carrier with an annular sleeve disposed around a flexible member.

### BACKGROUND OF THE INVENTION

Various tire carriers have been proposed in the past to store spare tires beneath a motor vehicle. See for example, Wagner, U.S. Pat. No. 4,613,273; Ng, U.S. Pat. No. 5,368,280; and Simnacher, U.S. Pat. No. 5,791,859. However none of these prior art designs disclose or suggest the present invention.

The present invention is directed toward improving upon prior devices and methods adapted for storing a spare tire on a motor vehicle. The apparatus of the present invention includes a tire carrier assembly with a winch assembly connected to the motor vehicle. The winch assembly includes a flexible member. Additionally, a tire carrier is connected to the flexible member. The winch assembly is operative to raise and lower the tire carrier between the stored position wherein the tire is inaccessible and a deployed position wherein the tire is accessible. The tire carrier includes a tire plate formed to support the spare tire, an annular sleeve disposed around the flexible member and a stop member attached to the flexible member. The annular sleeve has one end, an opposite end, an inner surface and one of a contoured inner surface, a polymeric layer and a polymeric insert to prevent wear and failure of the flexible member. The contoured inner surface has an interior surface forming a flared inside surface extending from the one end toward the opposite end, the flared surface having a first inside diameter “D1” adjacent the one end, a second inside diameter “D2” that is less than “D1” and extending away from the one end, and the length “L” extending between “D1” and “D2”, the difference between “D1” and “D2” divided by “L” ranging from 0.1 to 3.5.

The present invention also provides for a polymeric insert member that is disposed in the annular sleeve. The present invention additionally provides for forming the polymeric layer on the inner surface of the annular sleeve.

Included in the present invention is a method for storing a spare tire in a motor vehicle. The method includes providing a winch assembly connected to the motor vehicle. The winch assembly includes a flexible member. Additionally, connecting a tire carrier to the flexible member. The winch assembly is operative to raise and lower the tire carrier between a stored position and a deployed position wherein the tire carrier is accessible. The tire carrier includes a tire plate formed to support the spare tire, an annular sleeve disposed around the flexible member and a stop attached to the flexible member. The annular sleeve has one end, an opposite end, an inner surface and one of a polymeric layer, a contoured interior surface and a polymeric insert to prevent failure of the flexible member. The contoured inner surface has an interior surface forming a flared inside surface extending from the one end toward the opposite end, the flared surface having a first inside diameter “D1” adjacent the one end, a second inside diameter “D2” that is less than “D1” and extending away from the one end, and a length “L” extending between “D1” and “D2”, the difference between “D1” and “D2” divided by “L” ranging from 0.1 to 3.5. The polymeric insert is disposed in the annular sleeve. The polymeric layer is adjacent the inner surface of the sleeve.

From the foregoing disclosure, and the following more detailed description of the various preferred embodiments, it will be apparent to those skilled in the art that the present invention provides a significant advance in the technology and art of tire carrier assemblies. Particularly significant in this regard is the potential the invention affords for providing a high quality, feature rich, low cost assembly. Additional features and advantages of various preferred embodiments will be better understood in view of the detailed description provided below.

### BRIEF DESCRIPTION OF THE DRAWINGS

The features of the present invention will be apparent with reference to the following description and drawings, wherein:

FIG. 1 is a side view of the tire carrier assembly according to the present invention;

FIG. 2 is a cross-sectional view of the annular sleeve of an embodiment of the tire carrier assembly according to the present invention;

FIG. 3 is a planar view of FIG. 2;

FIG. 4 is a cross-sectional view of another embodiment of the annular sleeve of the tire carrier according to the present invention;

FIG. 5 is a cross-sectional view of still yet another embodiment of the annular sleeve of the tire carrier according to the present invention.

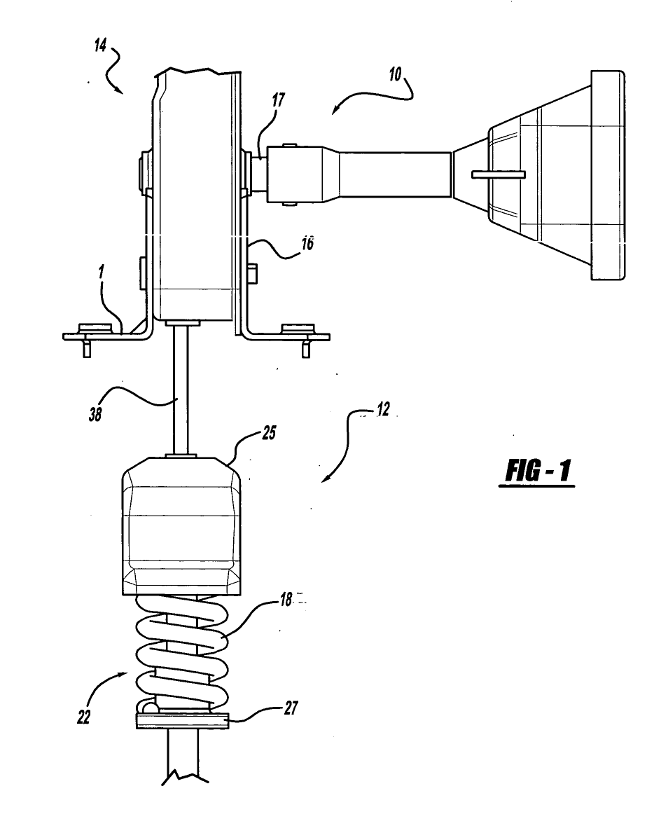

It should be understood that the appended drawings are not necessarily to scale, presenting a somewhat simplified representation of various preferred features illustrative of the basic principles of the invention. The specific design features of a tire carrier as disclosed herein, including, for example, specific shapes and inner contours of the annular sleeve member or the shape of the tire plate will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the tire carrier illustrated in the drawings. In general, up or upward refers to an upward direction in the plane of the paper and down or downward refers to a downward direction in the plane of the paper in FIGS. 1-5.

### DETAILED DESCRIPTION OF CERTAIN PREFERRED EMBODIMENTS

It will be apparent to those skilled in the art, that is, that those who have knowledge or experience in this area of technology, that many uses and design variations are possible for the tire carrier disclosed herein. The following detailed discussion of various alternative and preferred embodiments will illustrate the general principles of the invention with reference to a tire carrier for use with a motor vehicle. Other embodiments suitable for other applications will be apparent to those skilled in the art given the benefit of this disclosure.

Referring now to drawings, FIG. 1 illustrates' a tire carrier assembly 10 for a spare tire (not shown) of a motor vehicle 1, such as a van or truck, according to the present invention. While the illustrated embodiments of the present invention are particularly adapted for use with a van or truck it is noted that the present invention can be utilized with any motor vehicle having tires such as automobiles, recreational vehicles, sport utility vehicles (SUVs) medium to heavy duty trucks, buses, off road vehicles such as dune buggies, industrial equipment, construction equipment, golf carts and the like.

The tire carrier assembly 10 includes a tire carrier 12 for carrying and supporting a spare tire thereon, winch assembly 14 for raising and lowering the tire carrier between an upper or storing position and a lower or accessing position, housing assembly 16 for at least partially housing the winch assembly and mounting the various components to the motor vehicle. The winch 14 has a shaft which can be manually operated by a handle (not shown) or driven by a motor (not shown) which can include being powered by hydraulic, pneumatic and electric means and appropriate controls well known in the art. One end of a flexible member 38 is connected to the winch 14.

Winch assembly 14 is connected to the motor vehicle. The winch 14 includes a shaft 17, a spool or reel rotatable with the shaft and flexible member 38. Member 38 includes a cable, rope, chain or cord that is wound onto and off of the reel through a passage in the bottom of a housing. The shaft extends outwardly from housing assembly 16. The shaft is mounted for rotation about its central axis. The reel is mounted for rotation with shaft 17 and is adapted to wind and unwind the flexible member 38 thereon upon rotation of the shaft either manually or by a motor.

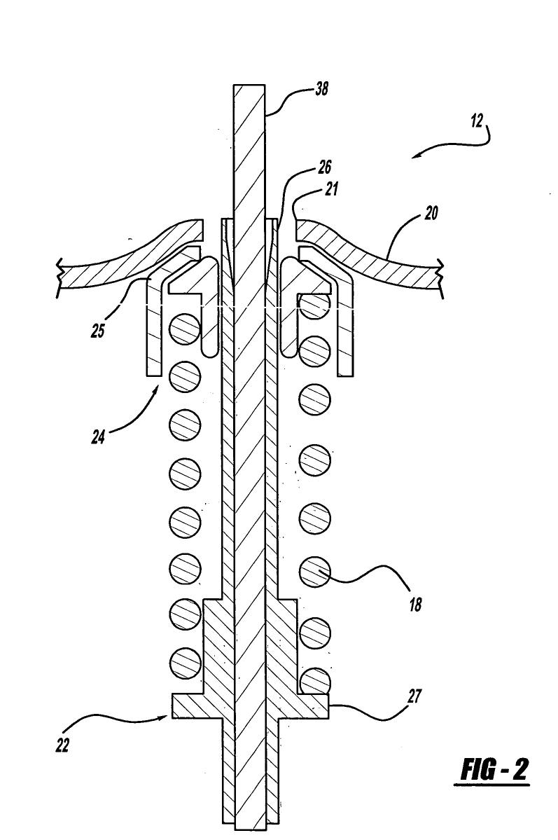

As shown in FIG. 2 the tire carrier 12 includes tire plate 20, annular sleeve 22, and a stop 24. The tire plate is adapted for supporting the spare tire and has a central aperture 21. It should be noted that the tire plate 20 may take on many different forms. The sleeve extends vertically through aperture 21 of the tire plate and receives the other end of the flexible member. The sleeve 22 is fastened to the flexible member by conventional means such by crimping or welding or soldering as is well known in the art. The sleeve includes tubular portion 26, which extends above the top of the tire plate. The tubular portion can take on many different shapes depending on the application requirements and the interaction with other components as will he discussed later on herein. The illustrated tubular portion is generally cylindrical and extends longitudinally and may optionally include a separate swivel member to permit rotational movement between the flexible member and the tire carrier. Stop 24 is attached by conventional means to the sleeve and preferably near the tubular portion so as to support the tire carrier. The stop has a flanged portion 27 near one end and a swivel member with a contoured surface 25 near the opposite end to permit the tire carrier to center itself and movement of the tire carrier relative to the sleeve and to allow free rotation of tire plate 20 thereon. The member with the contoured surface has an outer diameter that is larger than an inner diameter of aperture 21 to prevent stop 24 from passing through the aperture 21 and to support the tire carrier and optionally, the spare tire when the winch assembly raises or lowers the tire carrier and optionally, the spare tire thereon. Optionally, a biasing member 18 is disposed about sleeve 22 against flanged portion 27 to urge portion 27 away from stop 24. The biasing member also serves to absorb any impact loads on the flexible member 38 due to poor road conditions, such as a pot hole, an uneven road surface, etc.

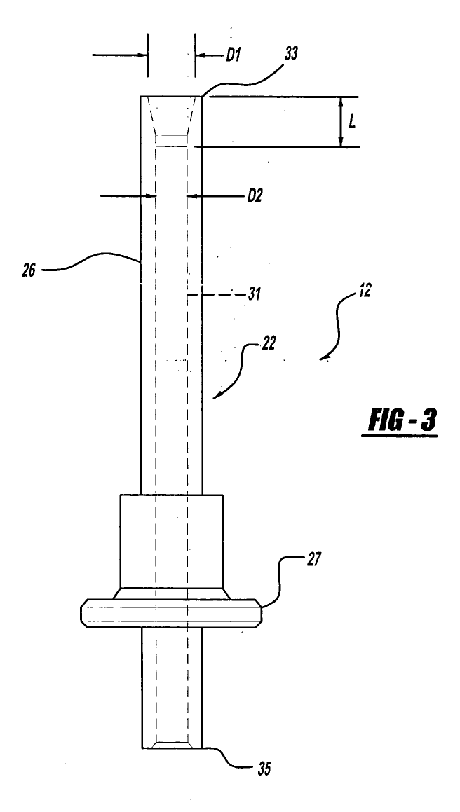

The inside surface 31 away from the top end 33 and toward the bottom end 35 of the sleeve is contoured. The contoured surface varies with the longitudinal length of the sleeve as shown in FIG. 3 In the illustrated embodiment, the top end is formed with a radius and the inner surface has a contoured surface that flares inwardly along an inclined path from the top end 33 with a first inner diameter of “D1”, a second inner diameter “D2” that is less than “D1” extends away from the top end a length “L” between “D1” and “D2”. The arithmetical difference between “D1” and “D2” divided by “L” forms a ratio “(D1-D2)/L” that varies between 0.1 and 3.5 and optionally, between 0.35 to 2.0. Optionally, the contoured inner surface of the sleeve may also be arcuate, slanted and angled. It has been found when the tire carrier and the optional spare tire become loose, the tire carrier and spare tire will move relative to the vehicle and the flexible member will rub against the inner surface of the sleeve. If the inner surface has any discontinuous surfaces with protruding sharp edges, the edges may cause the flexible member to wear with the time depending on the relative hardness of the two components. By providing a contoured surface extending from the top end of the sleeve according to the ratio of (D1-D2)/L in the above range between 0.1 and 3.5, the flexible member is prevented from being subject to excessive bending stresses adjacent the top end of the annular member when the flexible member bends excessively at an attitude from normal. This condition can exceed the flexible member's flex fatigue material limit and cause failure of the flexible member.

During operation of the tire carrier assembly, the spare tire is normally secured in the motor vehicle in a tire storing position. When the operator desires to lower the tire and tire carrier 12 from the storing position to the accessing position, the operator rotates the winch by suitable means to wind the flexible member from the reel to lower the tire carrier and optionally, the spare tire from the vehicle.

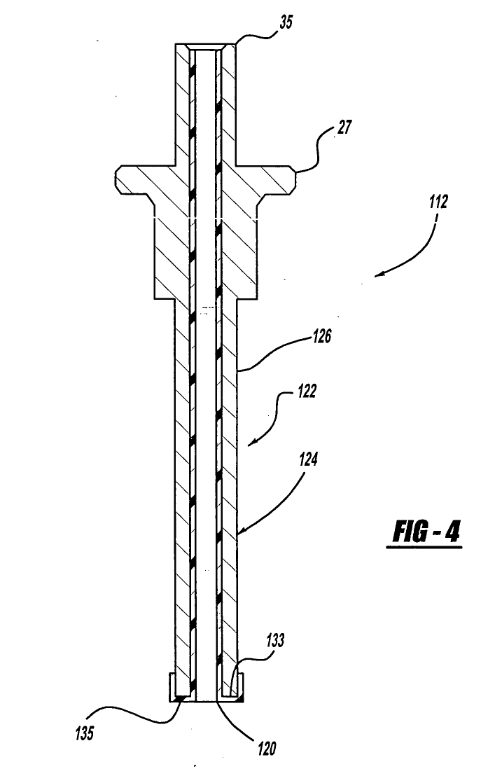

In another embodiment of the invention, as shown in FIG. 4, the tire carrier 112 is the same as in tire carrier assembly 10 where the same numerals are used to indicate the same elements as previously described except as now noted. In this embodiment, the tire carrier has a tubular portion 126 with an annular sleeve 122 with an inner surface 124 and a polymeric insert 120. The insert is pressed or adhesively bonded or otherwise fastened or connected by conventional means to the inner surface of the annular sleeve. The polymeric insert may be made of a thermoplastic material such as, polypropylene or the like, or polyurethane or the like, or a thermoplastic elastomer such as is available under trade name of Santoprene or plastomer or a thermoset material such as polyester or vinylester or the like, or an elastomer such as, natural rubber or an engineered elastomer such as, polyisoprene, butyl rubber, nitrile, EPDM, or the like. The inner surface of the insert 120 may be straight sided or contoured. The insert 120 acts as a barrier to absorb a portion of the force of the flexible member 38 exerted against the tubular portion 126 and to cover any discontinuous inside surface that may have sharp edges on the inner surface 124 to reduce wear and flex fatigue in the flexible member. Optionally, the insert may have a cap portion with arcuate inner surface that extends from the inner surface to above the top end. In all other aspects, the carrier 110 operates as in the tire carrier 10.

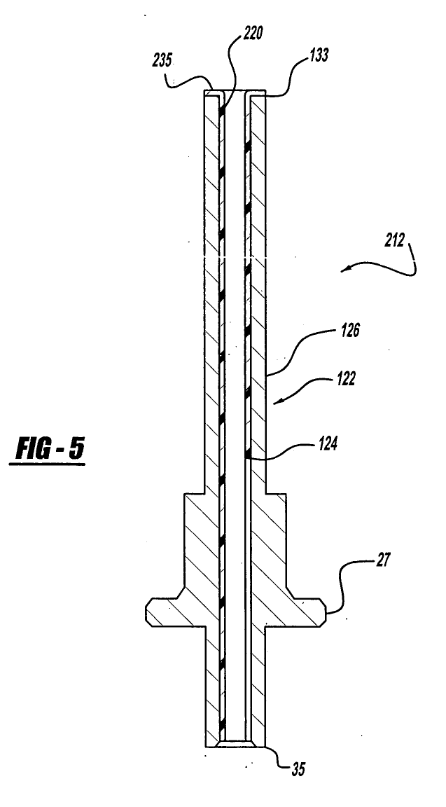

In still another embodiment of the invention, as shown in FIG. 5, the tire carrier 212 is the same as in tire carrier 10 where the same numerals are used to indicate the same elements as previously described except as now noted. In this embodiment, the carrier 212 has a tubular portion 126 with an annular sleeve 122 with a barrier coating 220. The inner surface 124 of the annular sleeve 122 is coated with a layer of polymeric material. The polymeric material includes a plastic material, such as polyurethane, thermoplastic or thermoplastic elastomer or a plastomer or an elastomer or polyurethane or the like. The sleeve can be dipped into a liquid bath of polymeric material such as plastic material or elastomer material or polyurethane so that the inside and outside surfaces are coated with an appropriate thickness of material. Optionally, the inner surface of the annular sleeve may be coated with an adhesive to promote adhesion of the polymeric material prior to dipping or coating of the inner surface 124. Further optionally, the inner surface may be spray coated with polymeric material such as plastic or elastomer or polyurethane materials by well-known methods. The inner surface 124 may be contoured or straight sided and the layer or barrier coating can extend over the top end of the annular member to form a cap 235. The end of the annular member near the top end may optionally have a radius. In this embodiment, all other aspects the carrier 210 operates as in the tire carrier 10.

From the foregoing disclosure and detailed description of certain preferred embodiments, it will be apparent that various modifications, additions and other alternative embodiments are possible without departing from the true scope and spirit of the present invention. For example, it will be apparent to those skilled in the art, given the benefit of the present disclosure, that the annular sleeve can have many shapes and the length, the inner diameter and of the annular sleeve can be varied depending on the application constraints of the vehicle. The annular sleeve may also have an inner diameter with a straight side or angled or contoured and a separate polymeric cap fastened or molded to the top end. The embodiments discussed were chosen and described to provide the best illustration of the principles of the present invention and its practical application to thereby enable one of ordinary skill in the art to utilize the invention in various embodiments and with modifications as are suited to the particular use contemplated. All such modifications and variations are within the scope of the present invention as determined by the appended claims when interpreted in accordance with the benefit to that they are fairly, legally and equitably entitled.

The invention as claimed is:

1. A tire carrier assembly for storing a spare tire on a motor vehicle comprising, in combination:
a winch assembly connected to the motor vehicle, the winch assembly including a flex member; and
a tire carrier connected to the flexible member, the winch assembly being operative to lower and raise the tire carrier between a stowed position wherein the tire carrier is inaccessible and a deployed position wherein the tire carrier is accessible, the tire carrier including a tire plate formed to support the spare tire, an annular sleeve disposed around the flexible member and a stop attached to the annular sleeve, the annular sleeve having a one end, an opposite ends an inner surface and on of polymeric layer, a contoured interior surface and a polymeric insert to prevent failure of the flexible member, the contoured interior surface having a flared inside surface extending from the one end toward the opposite end, the flared surface having a first inside diameter “D1” adjacent the one end, a second inside diameter “D2” that is less then “D1” and extending away from the one end, and the length “L” extending between “D1” and “D2”, the difference between “D1” and “D2” divided by “L” ranging from 0.1 to 3.5.

2. The tire carrier of claim 1 wherein the polymeric insert is disposed in the annular sleeve.

3. The tire carrier of claim 1 wherein the polymeric layer is formed on the inner surface of the sleeve.

4. The tire carrier of claim 2 wherein the inner surface is one of contoured and straight sided.

5. The tire carrier of claim 3 wherein the inner surface is one of contoured and straight sided

6. The tire carrier of claim 1 wherein the difference between “D1” and “D2” divided by “L” forming a ratio of (D1-D2)/L in the range of 0.35 to 2.0.

7. The tire carrier of claim 1 wherein the polymeric layer forms a cap on the annular sleeve.

8. The tire carrier of claim 1 wherein the polymeric insert has a cap portion.

9. The tire carrier of claim 1 wherein the polymeric insert is formed of a plastic material

10. The tire carrier of claim 1 wherein one of the polymeric insert and the polymeric layer is selected from the group of a plastic, an elastomer and a plastomer.

11. The tire carrier of claim 1 wherein the polymeric layer is polyurethane.

12. The tire carrier as claimed in claim 1 wherein one of the polymeric layer and a polymeric insert forms a barrier to absorb a portion of the force exerted by the flexible member on the sleeve.

13. A method of storing a spare tire on a motor vehicle, comprising:
providing a winch assembly connected to the motor vehicle, the winch assembly including a flexible member; and
connecting a tire carrier to the flexible member, the winch assembly being operative to lower and raise the tire carrier between a stowed position wherein the tire carrier is inaccessible and a deployed position wherein the tire carrier is accessible, the tire carrier including a tire plate formed to support the spare tire, an annular sleeve disposed around the flexible member and a stop attached to the annular sleeve, the annular sleeve having one end, an opposite end, an inner surface and one of a polymeric layer, a contoured inner surface and a polymeric insert to prevent wear and the failure of the flexible member, the contoured interior surface forming a flared inside surface extending from the one end toward the opposite end, the flared surface having a first inside diameter “D1” adjacent the one end, a second inside diameter “D2” that is less than “D1” and extending away from the one end, and the length “L” extending between “D1” and “D2”, the difference between “D1” and “D2” divided by “L” ranging from 0.1 to 3.5.

14. The method as claimed in claim 13 wherein the difference between “D1” and “D2” divided by “L” forming a ratio of (D1-D2)/L in the range of 0.35 to 2.0.

15. The method as claimed in claim 13 wherein the polymeric layer forms a cap on the annular sleeve.

16. The method as claimed in claim 13 wherein one of the polymeric layer and the polymeric insert is selected from the group of a plastic, an elastomer and a plastomer.

17. The method as claimed in claim 13 wherein the contoured interior surface prevents excessive bending stresses in the flexible member.

18. The method as claimed in claim 13 wherein the polymeric layer is polyurethane.

19. The method as claimed in claim 13 wherein the polymeric insert has a cap.

20. The method as claimed in claim 13 wherein one of the polymeric layer and polymeric insert forms a barrier to absorb a portion of the force exerted by the flexible member on the sleeve.
